(19) United States
(12) Patent Application Publication
(10) Pub. No.: US 2017/0265045 A1
(43) Pub. Date: Sep. 14, 2017

(54) METHOD AND APPARATUS FOR DYNAMIC LOCATION-BASED GROUP FORMATION FOR ENSURING REQUIRED RESPONDERS

(71) Applicant: MOTOROLA SOLUTIONS, INC, Schaumburg, IL (US)

(72) Inventors: ALEXEI VLADIMIROVICH IGUMNOV, ST. PETERSBURG (RU); FEDOR GRIGORIEVICH SAVELIEV, ST. PETERSBURG (RU)

(21) Appl. No.: 15/114,414

(22) PCT Filed: Mar. 24, 2014
(86) PCT No.: PCT/RU2014/000185

§ 371 Date: Jul. 27, 2016

(51) Int. Cl. H04W 4/08; H04W 4/02; H04W 4/22; H04W 4/10

(52) U.S. Cl. CPC H04W 4/08; H04W 4/10; H04W 4/022; H04W 4/22; H04W 4/027; H04W 4/04

(57) ABSTRACT

A dynamic location-based group is formed that ensures required responders. A request for a new location-based group call relative to a defined location is received at a controller from an initiating device. The controller determines a plurality of required responder types for responding to the location and forms a group including subscriber units meeting one of a plurality of required responder types and a set of location-based group formation rules. The controller then determines if subscriber units in the formed group meet the required responder types. If not, the controller modifies the location-based group formation rules and re-forms the group including subscriber units meeting one of the plurality of required responder types and the modified location-based group formation rules. The controller then causes audio or data transmitted by the initiating device to be provided to the subscriber units in the re-formed group.

### BACKGROUND OF THE INVENTION

Radio access networks (RANs) provide for radio communication links to be arranged within the network between a plurality of user terminals. Such user terminals may be mobile and may be known as ‘mobile stations’ or ‘subscriber units.’ At least one other terminal, e.g. used in conjunction with subscriber units (SUs), may be a fixed terminal, e.g. a base station, eNodeB, repeater, and/or access point. Such a RAN typically includes a system infrastructure that generally includes a network of various fixed terminals, which are in direct radio communication with the SUs. Each of the fixed terminals operating in the RAN may have one or more transceivers which may, for example, serve SUs in a given region or area, known as a ‘cell’ or ‘site’, by radio frequency (RF) communication. The SUs that are in direct communication with a particular fixed terminal are said to be served by the fixed terminal. In one example, all radio communications to and from each SU within the RAN are made via respective serving fixed terminals. Sites of neighboring fixed terminals may be offset from one another and may be non-overlapping or partially or fully overlapping with one another. In another example, SUs may communicate within a network without the assistance of one or more infrastructure equipment (e.g., base stations or repeaters), in a mode called direct mode. For example, in direct mode, SUs may transmit asynchronously and SUs s within range of the transmission synchronize themselves to that transmission for the purposes of receiving the transmission, but any transmissions in response to or after the first transmission are transmitted asynchronously.

RANs may operate according to any one of a number of available industry standard protocols such as, for example, an open media alliance (OMA) push to talk (PTT) over cellular (OMA-PoC) standard, a voice over IP (VoIP) standard, or a PTT over IP (PoIP) standard. Typically, protocols such as PoC, VoIP, and PoIP are implemented over broadband RANs including third generation and fourth generation networks such as third generation partnership project (3GPP) Long Term Evolution (LTE) networks.

RANs may additionally or alternatively operate according to an industry standard land mobile radio (LMR) protocol such as, for example, the Project 25 (P25) standard defined by the Association of Public Safety Communications Officials International (APCO), or other radio protocols, the Terrestrial Trunked Radio (TETRA) standard defined by the European Telecommunication Standards Institute (ETSI), the Digital Private Mobile Radio (dPMR) standard also defined by the ETSI, or the Digital Mobile Radio (DMR) standard also defined by the ETSI. Because these systems generally provide lower throughput than the 3GPP and LTE systems, they are sometimes designated narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) protocols. Subscriber units in RANs such as those set forth above send and receive audio and/or data (e.g., encoded voice, audio, video, control information, data, and/or audio/video streams) in accordance with the designated protocol.

OMA-PoC, in particular, enables familiar PTT and “instant on” features of traditional half duplex SUs, but uses SUs operating over modern cellular telecommunications networks. Using PoC, SUs such as mobile telephones and notebook computers can function as PTT half-duplex SUs for transmitting and receiving auditory data. Other types of PTT models and multimedia call models (MMCMs) are also available.

Floor control in an OMA-PoC session is generally maintained by a PTT server that controls communications between two or more SUs. When a user of one of the SUs keys a PTT button, a request for permission to speak in the OMA-PoC session is transmitted from the user's SU to the PTT server using, for example, a real-time transport protocol (RTP) message. If no other users are currently speaking in the PoC session, an acceptance message is transmitted back to the user's SU and the user can then speak into a microphone of the SU. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the received auditory data packets to other users of the PoC session (e.g., to other SUs in the group of SUs or talkgroup to which the user is subscribed), using for example a unicast, multicast, or broadcast communication technique.

Narrowband LMR systems, on the other hand, operate in either a conventional or trunked configuration. In either configuration, a plurality of SUs are partitioned into separate groups of SUs. In a conventional system, each SU in a group is selected to a particular frequency for communications associated with that SU's group. Thus, each group is served by one channel, and multiple groups may share the same single frequency (in which case, in some embodiments, group IDs may be present in the group data to distinguish between groups using the same shared frequency). Communications in a conventional system may take place via an infrastructure-provided repeater or repeaters, or directly via a direct mode (including talk-around) protocol.

In contrast, a trunked radio system and its SUs use a pool of traffic channels for virtually an unlimited number of groups of SUs (e.g., talkgroups). Thus, all groups are served by all channels. The trunked radio system works to take advantage of the probability that not all groups need a traffic channel for communication at the same time. When a member of a group requests a call on a control or rest channel on which all of the SUs in the system idle awaiting new call notifications, in one embodiment, a call controller assigns a separate traffic channel for the requested group call, and all group members move from the assigned control or rest channel to the assigned traffic channel for the group call. Communications then take place via the assigned traffic channel repeater. In another embodiment, when a member of a group requests a call on a control or rest channel, the call controller may convert the control or rest channel on which the SUs were idling to a traffic channel for the call, and instruct all SUs that are not participating in the new call to move to a newly assigned control or rest channel selected from the pool of available channels. With a given number of channels, a much greater number of groups can be accommodated in a trunked system as compared with conventional radio systems. In a trunked system, communications may also take place directly between SUs when operating in a talk-around mode (e.g. direct mode when infrastructure devices are also available).

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a radio controller, call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., SUs) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, SUs may dynamically affiliate with a group (and also disassociate with the group) perhaps based on user input, and the switching and/or radio network may track group membership and route new group calls according to the current group membership. In some instances, a group of SUs may be identified as a talkgroup, and a call initiated to members of that talkgroup (whether including the transmission of audio and/or data and/or video to a group of target SUs) may be a identified as a talkgroup call.

One problem that has arisen with the use of talkgroups to distribute auditory or other data to member SUs is that a situation may arise where an incident occurs or a response is otherwise required at a defined location, and a responder may wish to dynamically create a location-based talkgroup relative to that defined location so that responding personnel may communicate with one another and coordinate a response between them. Existing methods of dynamically creating such a location-based talkgroup have relied upon pre-configured static distances from the defined location to determine which responding personnel (and corresponding SUs) should be included in the location-based talkgroup.

For example, as shown in FIG. 1, an incident/response area 100 may have a defined location 102 and may have a response boundary 104 statically defined at a fixed distance 106 from the defined location 102. Various potential responders (each of which may also already be a member of a corresponding incident response group, such as police, fire, or traffic control) may already be on scene or within the response boundary 104 at the time of the incident. Each potential responder may be a person or vehicle with an associated SU (e.g., portable or vehicular SU) capable of communicating wirelessly with each other and/or with a RAN 126. Such potential responding SUs may include, for example, first pedestrian responding SU 112A (e.g., an officer operating on-foot), a motor vehicle responding SU 114A (e.g., police car), and a motor vehicle responding SU 118A (e.g., ambulance). Other potential responding SUs may fall within incident/response area 100 but outside of the response boundary 104, including for example, second pedestrian responding SU 112B, motor vehicle responding SUs 114B and 114C, motor vehicle responders SUs 116A and 116B, and a motor vehicle responding SU 118B.

Each of the potential responding SUs may, in one example, already be actively using RF resources 128 of the RAN 126, which may be a LMR or LTE RAN providing coverage substantially throughout the incident/response area 100, illustrated in FIG. 1 as including a single fixed terminal 130 coupled to a controller 132 (e.g., radio controller, call controller, PTT server, zone controller, MME, BSC, MSC, site controller, Push-to-Talk controller, or other network device) and including a dispatch console 134. As illustrated in FIG. 1, using the statically defined response boundary 104 to dynamically set a location-based group membership for an incident or response required at or near the defined location 102 may cause some potential responding SUs to be included in the location-based group that should not be, and on the other hand, may fail to include some potential responding SUs in the location-based group that should be.

For example, an incident occurring at the defined location 102 may be or include a fire. However, because both fire engine motor vehicle responders SUs 116A and 116B are outside of the response boundary 104, neither is included in the location-based group. Furthermore, police car motor vehicle responding SU 114A may be included in the location-based group even though it is currently involved in another call (e.g., is busy and unavailable to assist in a response).

Accordingly, for this and other reasons, there is a need for an improved method and apparatus for dynamically forming location-based groups so that incident and other types of response groups are created that include required responders.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of an existing incident/response area illustrating issues that may arise when using static distance parameters.

FIG. 2 is a schematic diagram of a first incident/response area illustrating dynamic location-based group formation ensuring required responders in accordance with an embodiment.

FIG. 3 is a schematic diagram of a second incident/response area illustrating dynamic location-based group formation ensuring required responders in accordance with an embodiment.

FIG. 4 is a block diagram of a controller device capable of dynamically forming location-based groups ensuring required responders in accordance with an embodiment.

FIGS. 5A and 5B set forth a flow chart illustrating processing steps executable at the controller device of FIG. 4 for dynamically forming location-based groups ensuring required responders in accordance with an embodiment.

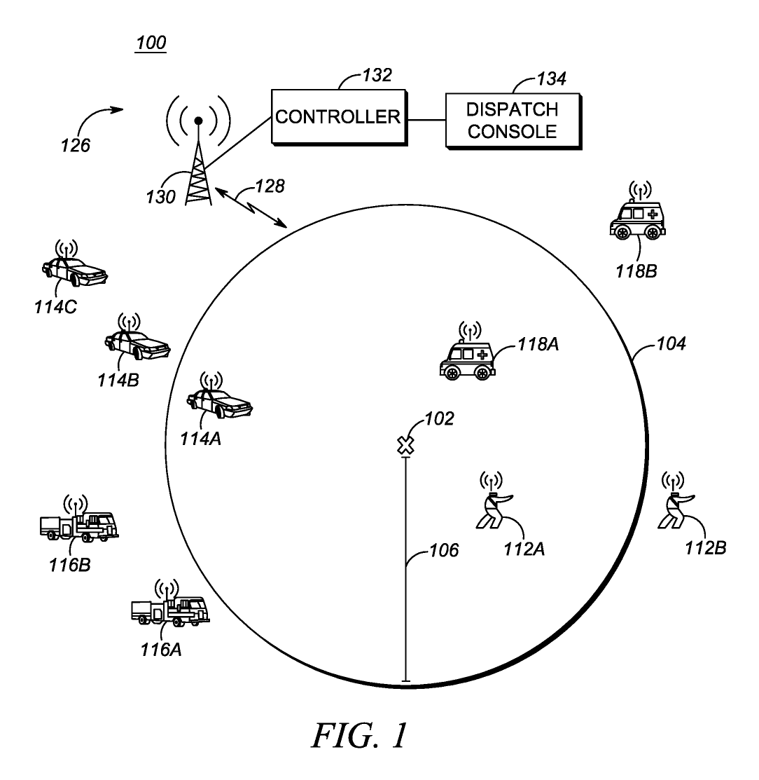

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed is an improved method and apparatus for dynamically forming location-based groups ensuring inclusion of required responders, and as a result, location-based response groups may be created more efficiently and effectively.

In one embodiment, a dynamic location-based group is formed that ensures required responders. A request for a new location-based group call relative to a defined location is received at a controller from an initiating device. The controller determines a plurality of required responder types for responding to the location and forms a group including subscriber units meeting one of a plurality of required responder types and a set of location-based group formation rules. The controller then determines if subscriber units in the formed group meet the required responder types. If so, the controller then causes audio or data transmitted by the initiating device to be provided to the subscriber units in the formed group. If not, the controller then modifies the location-based group formation rules and re-forms the group including subscriber units meeting one of the plurality of required responder types and the modified location-based group formation rules. The controller then causes audio or data transmitted by the initiating device to be provided to the subscriber units in the re-formed group.

In another embodiment, a controller for dynamic group formation that ensures required responders includes a transceiver; a data store; and one or more processors. The one or more processors are configured to: receive from an initiating device, via the transceiver, request for a new location-based group call relative to a defined location; determine a plurality of required responder types for responding to the location and form a group including subscriber units meeting one of a plurality of required responder types and a set of location-based group formation rules; and determine if subscriber units in the formed group meet the required responder types. If the one or more processors determine that subscriber units in the formed group meet the required responder types, the one or more processors cause, via the transceiver, audio or data transmitted by the initiating device to be provided to the subscriber units in the formed group. If the one or more processors determine that subscriber units in the formed group do not meet the required responder types, the one or more processors are configured to modify the location-based group formation rules and re-form the group including subscriber units meeting one of the plurality of required responder types and the modified location-based group formation rules, and to then cause, via the transceiver, audio or data transmitted by the initiating device to be provided to the subscriber units in the re-formed group.

Each of the above-mentioned embodiments will be discussed in more detail below, starting with example incident/response area schematic diagrams of areas in which the embodiments may be practiced, followed by an illustration of devices and processing steps for supporting dynamic location-based group formation ensuring inclusion of required responders. Further advantages and features consistent with this disclosure will be set forth in the following detailed description, with reference to the figures.

### 1. EXAMPLE INCIDENT/RESPONSE AREA AND LOCATION-BASED GROUP MEMBERSHIP FOR ENSURING INCLUSION OF REQUIRED RESPONDERS

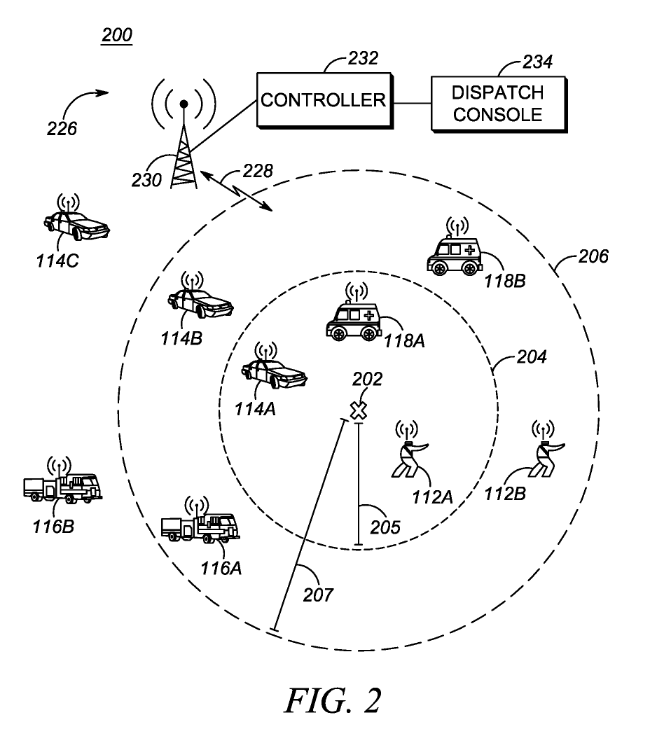

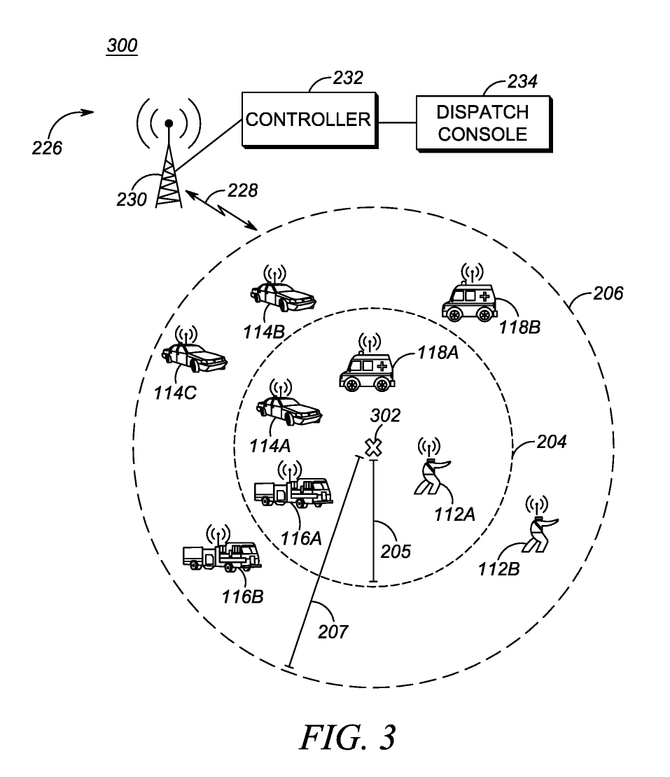

FIGS. 2 and 3 illustrate different incident/response areas in which disclosed embodiments may be practiced. FIG. 2, for example, illustrates a first example incident/response area 200 including a defined location 202 at which an incident has occurred or a response is otherwise required, a plurality of potential responding SUs 112A, 112B, 114A, 114B, 114C, 116A, 116B, 118A, 118B of varying responder types, and a RAN 226. SUs 112A and 112B are of a traffic or crowd control officer responder type, SUs 114A-114C are of a police car responder type, SUs 116A-116B are of a fire engine responder type, and SUs 118A-118B are of an ambulance responder type.

The defined location 202 may be entered in or reported manually by a first responder on-scene (for example, responding SU 112A in FIG. 2), could be automatically determined by a determined location of some other potential responding SU that is at the defined location 202 (not illustrated in FIG. 2), or could be set by a dispatcher at a dispatch console 234 communicatively coupled to the controller 232 (e.g., after receiving a report from a potential responding SU in the field or via some other mechanism, such as a plain old telephone (POT) system call received at or forwarded to the dispatch console 234).

In this example, four different responder types are illustrated, and two different distances are illustrated as being used in determining which potential responding SUs to group into a location-based group for responding to the defined location 202, dependent on which responder types are required for responding to the defined location 202, among other parameters. Of course, in other examples, more or fewer responder types and more or fewer different distances than those illustrated in FIG. 2 could be implemented.

A first/initial perimeter 204 is defined at a distance 205 from the defined location 202 and a second perimeter 206 is defined at a distance 207 from the defined location 202. While each of the perimeters 204, 206 is illustrated as a concentric circle centered on the defined location 202, in other examples, the perimeters may not be concentric (e.g., may be offset based on a defined meeting location for each responder type or perhaps based on an entry location to a building or other type structure that may differ based on the responder type), or may be based on some other form of cartographic definition, such as a set of three or more polygon vertices, where each polygon vertex is a GPS coordinate, such as a latitude and longitude pair, or some other form of cartographic definition, again having a center at the defined location 202 or slightly offset from the defined location 202. Other examples are possible as well.

Radio access network (RAN) 226 provides wireless communications services to all potential responding SUs in the incident/response area 200 via fixed terminal 230 and wireless resource 228. The controller 232 in RAN 226 may include a mapping that maps each potential responding SU with a responder type with which it is currently associated. While controller 232 is illustrated in FIG. 2 as being within RAN 226, in other embodiments, controller 232 may be located outside of RAN 226 and accessible by RAN 226 via a separate wired or wireless communications interface.

In FIG. 2, the wireless resource 228 may be, for example, one or more wireless links supporting a standard or protocol such as GPRS or UMTS, 2G (e.g. GSM), 3G (e.g. WCDMA or Long Term Evolution (LTE)), 4G (WiMAX or LTE), iDEN, wireless LAN (WLAN), ETSI Digital Mobile Radio (DMR), Project 25 (P25) standard defined by the Association of Public Safety Communications Officials International (APCO), Terrestrial Trunked Radio (TETRA), or other radio protocols or standards.

Each potential responding SU may be a group communications device, such as a push-to-talk (PTT) device, that is normally maintained in a monitor only mode, and which switches to a transmit-only mode (for half-duplex devices) or transmit and receive mode (for full-duplex devices) upon depression or activation of a PTT input switch. The group communications architecture provided via RAN 226 allows a single potential responding SU, such as potential responding SU 112A, to communicate with one or more members (such as potential responding SUs 112B, 114A, 114B, 114C, 116A, and 118A) associated with a dynamically formed location-based group at the same time.

Although only one controller 232, one fixed terminal 230, and one wireless resource 228 is illustrated in FIG. 2, the present disclosure is not limited as such, and more controllers, more fixed terminals, and more wireless resources could be used in any particular implementation. Furthermore, while a single controller 232 is illustrated in FIG. 2, a distributed controller may be used that divides functions across multiple devices, perhaps for load balancing reasons. Controller 232 may additionally function as a call controller, PTT server, zone controller, mobile management entity (MME), base station controller (BSC), mobile switching center (MSC), site controller, Push-to-Talk controller, or other network device for aiding in the control and/or distribution of group auditory data or other types of group communications amongst responding SUs. Finally, and although not illustrated in FIG. 2, RAN 226 may further comprise one or more additional routers, switches, LANs, WLANs, WANs, access points, or other network infrastructure.

External networks (not shown) may also be accessible to potential responding SUs via RAN 226. External networks may include, for example, a public switched telephone network (PSTN), a plain old telephone (POT) system, the Internet, or another wireless service provider's network, among other possibilities.

Dispatch console 234 may be directly coupled to controller 232, as shown, or may be indirectly coupled to controller 232 via one or more internal or externals networks. The dispatch console 234 allows an administrator or dispatcher at a dispatch console to initiate infrastructure-sourced dynamic location-based group communications to groups of responding SUs relative to a defined location indicated by the dispatcher, among other features and functions.

The responder type with which a particular potential responding SU is associated may be manually configured by a network or system administrator or installer, may be manually set or reported to controller 232 by a user via a user-interface provided at each potential responding SU, or may be automatically reported to the controller 232. In one embodiment, responder type could be automatically reported based on a potential responding SU's instantaneous or average location in proximity to a known responder type location indicator. For example, if an instantaneous or average (e.g., usual) location for responding SU 116A is detected to be within a proximity of a firehouse, the responder type for SU 116A may be automatically set to fire engine and/or fireman. Similarly, if an instantaneous or average (e.g., usual) location for responding SU 114A is detected to be within a proximity of a police station, the responder type for SU 114A may be automatically set to police car and/or police man. A detected instantaneous or average speed of an SU may be used to differentiate between a vehicle (e.g., fire engine or police car) and a pedestrian (e.g., fireman or police man). Other possibilities exist as well.

In other embodiments, a responder type may be determined analytically based on a type of potential responding SU device being used by a responder. For example, portable user equipment such as mobile two-way radios carried by pedestrian police officers and/or vehicular radios included in motor vehicles may have (partially or fully) unique identifiable radio IDs, device IDs, or manufacturer IDs that could be used to auto-populate a responder type associated with a particular responding SU. For example, a potential responding SU having a device ID beginning with AB₁₆ may indicate that it is a mobile two-way radio carried by a pedestrian fireman or police officer, while some other pre-configured string may indicate that it is a vehicular radio associated with a motor vehicle of a particular type. Other examples are also possible.

Groups are formed in the incident/response area 200 by controller 232 in view of a determined required responder types for a particular response to the defined location 202 and in view of a set of location-based group formation rules, among other possible parameters.

The responder types required for a response to the defined location may be determined in a number of ways. For example, the responder types required may determined as a function of one or more of (i) a responder type of a first, location-based group call requesting SU, (ii) a type of incident occurring at the defined location, and (iii) a content of the location-based group call request.

The responder type of the requesting SU could be determined in any of the ways already set forth above. The responder type of the requesting SU could then be used to index into a requesting device type to required responder types mapping (e.g., maintained within or external to the RAN 226) that indicates what required responder types should be included in any group of potential responding SUs as a function of the responder type of the requesting SU device. For example, an entry in a requesting device type to required responder types mapping may take the following form:

TABLE I
Example Requesting Device Type to Required
Responder Types Mapping

| Requesting SU | Requesting SU | Required | Quantity |
|---|---|---|---|
| Device ID: | Device Type: | Responders: | Required: |
| FFFF₁₆ | Police Car | Police Car | 1 |
| | | Fire Engine | 1 |
| | | Traffic Control | 2 |

In the example of Table I above, a requesting SU device having a device ID of FFFF₁₆ may be associated with a police car responder (such as responding SU 114A of FIG. 2). The requesting SU device ID in Table I may be an International Mobile Subscriber Identity (IMSI)) which may be connected to a physical media (such as a Subscriber Identity Module (SIM) card), a hardware radio medium access control address (MAC), an internet protocol (IP) address, or some other form of value capable of uniquely identifying individual requesting SU devices.

When the requesting SU device requesting the new location-based group is a police car responder type, the controller 232 may access the requesting device type to required responder types mapping of Table I and determine that a police car type responder, a fire engine type responder, and a traffic control type responder are required for responding to the defined location. In some embodiments, and as illustrated in Table I, a minimum required quantity of responders for each responder type may also be included in the mapping.

As set forth earlier, the type of incident occurring at the defined location could also be used to determine the required responders for responding to the defined location. The type of incident may be indicated in the new group call request transmitted by the requesting device, via some subsequent message transmitted by the requesting device, via a dispatcher at the dispatch console 234, or by some other means. The controller 232, in response to receiving an indication of the incident type, may then determine the required responders for responding to the defined location. For example, given an incident type, the controller 232 may access an incident type to required responder mapping (e.g., maintained within or external to the RAN 226) to determine what required responder types should be grouped into a location-based group as a function of the reported incident type.

TABLE II
Example Incident Type to Required Responder
Mapping

| Reported | Required | Quantity |
|---|---|---|
| Incident Type: | Responders: | Responders: |
| Residential | Fire Engine | 1 |
| House Fire | Ambulance | 1 |
| | Crowd Control | 1 |
| Industrial Fire | Fire Engine | 3 |
| | Ambulance | 2 |
| | Traffic Control | 3 |
| | Hazmat | 1 |
| Water Rescue | Coast Guard | 1 |
| | Ambulance | 2 |
| | Boat Recovery/Tow | 1 |

For example, when the reported incident type for the new location-based group is residential house fire, the controller 232 may access the incident type to required responder types mapping and determine that a fire engine responder type, an ambulance responder type, and a crowd control police officer responder type should be grouped together to respond to the defined location. Other examples could include more or less incident types, different incident types, different quantities of each responder type, and/or different mappings of incident types to required responder types, among other possibilities. Furthermore, which required responder types and a minimum or maximum quantity of responders for each responder type assigned to respond to any particular defined location could vary based on a number of other factors, including an incident level metric (e.g., a size of the incident, large or small), a priority of the incident relative to other incidents (e.g., based on involved persons, proximity to other high value targets or high population centers), and a location of the incident (e.g., distance from responder origination locations, proximity to other high value targets or high population centers), among other factors.

As set forth earlier, the content of the location-based group call request (or a subsequent message transmitted thereafter) could also be used to explicitly indicate the required responders for responding to the defined location. For example, the requesting device and/or the dispatcher operating the dispatch console may explicitly indicate, for any defined location included in a new location-based group call request, the required responders for responding to the defined location. This type of explicit indication of required responders may be especially useful in those situations that are unusual or difficult to predict, and allows the requesting device or dispatch console to explicitly indicate the required responders for responding to the defined location. For example, a new location-based group call request may include the following fields:

TABLE III
Example Explicit Signaling of Required Responder Types

| Requesting | | Required | Quantity | Maximum |
|---|---|---|---|---|
| Device ID: | Type of Call: | Responders: | Required: | Quantity: |
| FFFF₁₆ | Location- | Ambulance | 1 | 2 |
| | based Group | Hazmat | 2 | 2 |
| | Call | Crowd Control | 6 | 8 |

In the example of Table III above, a requesting device having a device ID of FFFF₁₆ may transmit a request to the controller 232 for a new location-based group call for an unusual situation such as a chemical leak, and explicitly request corresponding required responder types including an ambulance, a hazmat team, and crowd control officers to keep others away from potentially hazardous materials. In some embodiments, and equally applicable to every other method of informing controller 232 of required responder types, a maximum quantity of responders for each of, or all of, the specified required responder types may be listed and used to reduce a quantity of potential responding SUs added to any location-based group. In still further embodiments, and again equally applicable to every other method of informing controller 232 of required responder types, no minimum or maximum quantity of responder types may be specified for each responder type required, and the controller 232 may assume a minimum quantity of 1 for each responder type, with or without a pre-configured maximum quantity.

Once the controller 232 determines the plurality of required responder types to respond to the defined location, it then applies a default or initial set of location-based group formation rules relative to the defined location to create an initial group of responding SUs out of the potential responding SUs units meeting one of the plurality of required responder types for responding to the defined location. For example, the initial set of location-based group formation rules may include a default distance rule (e.g., one mile radius rule) relative to the defined location and an availability rule that only non-busy potential responding SUs be considered candidate responding SUs for the location-based group.

With respect to FIG. 2, distance 205 may be 1 mile and perimeter 204 may thus define an initial perimeter from which to group potential responding SUs in creating a group for responding to the defined location 202. For exemplary purposes only, assume that the incident occurring to the defined location is a residential house fire and that, in accordance with Table II above, a fire engine responder, an ambulance responder, and a crowd control responder are required responder types for responding to the defined location 202. Furthermore, assume that none of the potential responding SUs in FIG. 2 are currently busy. Applying the initial set of location-based group formation rules to potential responding SUs in FIG. 2 meeting one of the plurality of required responder types would result in an initial group including responding SU 118A (the required ambulance responder type) and/or SU 112A (the required crowd control responder type). Because there are no fire engine responder types meeting the requirements of the initial set of location-based group formation rules, and in particular, there are no fire engine responder types within the initial perimeter 204 of FIG. 2, a location-based group created using the initial set of location-based group formation rules fails to meet the required responder types associated with the defined location. When this occurs, the controller 232 must eliminate or modify one or more of the location-based group formation rules so that the required responder types can be met.

For example, with respect to FIG. 2, the distance parameter in the initial set of location-based group formation rules could be either eliminated in its entirety (and therefore consider all potential responding SUs known to controller 232 within incident/response area 200), or modified to a larger value. In this instance, increasing the distance parameter in the initial set of location-based group formation rules from 1 mile (205 in FIG. 2) to 2 miles (207 in FIG. 2), expanding the perimeter from 204 to 206, allows for the fire engine responding SU 116A to be included in the location-based group. After modifying (or eliminating) one or more rules in the initial set of location-based group formation rules to create a modified set of one or more location-based group formation rules, the modified set of location-based group formation rules are re-applied to the potential responding SUs of FIG. 2, and a resultant re-formed group would include responding SUs 118A and 118B (the required ambulance responder type), SUs 112A and 112B (the required crowd control responder type), and SU 116A (the required fire engine responder type).

As can be seen from this example, some location-based groups may be formed with more than the minimum required quantity of responders of each responder type. For example, while the residential house fire of Table II only requires a single ambulance type responder, in applying the modified set of one or more location-based group formation rules to the potential responding SUs of FIG. 2, a location-based group is created with two responding SUs 118A and 118B of the ambulance responder type. Depending on the situation or network configuration, this may be a desirable result, as additional (non-busy in this example) responders can aid in the response. However, in other situations or network configurations, it may be desirable to create a location-based group that includes either a maximum quantity of responders for each responder type, or exactly the minimum required quantity of responders for each responder type. In those situations in which application of the location-based group formation rules results in a group having more of a particular responder type than the minimum required quantity of responders for that particular responder type, a preference rule may be applied or added to the initial or modified location-based group formation rules that reduces the quantity of responders for that particular responder type to the maximum number or the minimum required quantity of responders for that particular responder type. A number of different types of preference rules could be applied to reduce the quantity of responders for a particular responder type, including for example, a distance preference rule that prefers those potential responding SUs having a current location closest to the defined location, an on-duty preference that prefers those responders that have been “on-duty” for the shortest amount of time, or a priority preference that prefers those responders having a higher priority assigned to them (including, for example, commanders or captains over lower designations), among other possibilities.

Current location information for each of the potential responding SUs could be periodically or intermittently reported and stored at the controller 232 or other device in the RAN 226 that is accessible to the controller 232. Knowing the location of the defined location 202 and the current location of each potential responding SU, the controller 232 could then calculate distances from each potential responding SU to the defined location 202 and apply the distance preference rule when forming the location-based group. An amount of time on-duty and/or priority preference may similarly be made available at the controller 232 or at some other device in the RAN 226 that is accessible to the controller 232. Accordingly, and for example, if the controller was configured to create location-based groups with only the minimum required quantity of responding SUs for each responder type and the distance preference rule were applied to the ambulance type responders 118A and 118B, since only one ambulance type responder is required for the residential house fire incident type of Table II, a re-formed group created with the distance preference rule applied would include only ambulance type responding SU 118A and not ambulance type responder 118B. A same or similar process and distance preference rule could also be applied to pedestrian responding SUs 112A and 112B such that, after application of the distance preference rule and in light of the single crowd control type responder required for a residential house fire incident type of Table II, the re-formed group with the distance preference rule applied would include only pedestrian type responding SU 112A and not pedestrian type responder 112B.

FIG. 3 illustrates a second example incident scene occurring at a defined location 302 within an incident/response area 300. Several reference characters used in FIG. 3 are the same as those used in as in FIG. 2, and their description is not repeated here. In the example of FIG. 3, the required responder types are specified by the location-based group requesting device (pedestrian responding SU 112A, for example) in the location-based group call request itself or in a subsequent message, and specifies the following required responder types and minimum quantities: Police Car x1; Fire Engine x1; Traffic Control x1.

Once the controller 232 determines the plurality of required responder types to respond to the defined location 302, it then applies a default or initial set of location-based group formation rules relative to the defined location 302 to create an initial group for responding to the defined location 302 in a same or similar manner to that set forth with respect to FIG. 2. For example, the initial set of location-based group formation rules may include a default 1 mile radius rule relative to the defined location and a rule that only non-busy responding SUs be considered candidate responding SUs for the location-based group.

With respect to FIG. 3, distance 205 may again be 1 mile and perimeter 204 may thus define an initial perimeter from which to group potential responding SUs in creating a location-based group for responding to the defined location 302. For exemplary purposes only, assume that police car type responding SU 114A is currently busy on another call or involved in another incident response, and as indicated at controller 232, and is thus not available to join the location-based group according to the initial set of location-based group formation rules.

Applying the initial set of location-based group formation rules to FIG. 3 would thus result in an initial group including responding SU 112A (the required traffic control responder type) and SU 116A (the required fire engine responder type). Because there are no police car responder types meeting the requirements of the initial set of location-based group formation rules, and in particular, there are no non-busy police car responder types within the initial perimeter 204 of FIG. 3, the location-based group created using the initial set of location-based group formation rules fails to meet the required responder types associated with the defined location 302. When this occurs, the controller 232 must again eliminate or modify one or more of the location-based group formation rules so that the required responder types can be met.

For example, with respect to FIG. 3, the distance parameter in the initial set of location-based group formation rules could be either eliminated in its entirety, or modified to a larger value, in a similar fashion to that set forth with respect to FIG. 2 above. As another option, the controller 232 could instead eliminate or modify the non-busy availability requirement to create a modified set of one or more location-based group formation rules that either does not consider busy status at all, or allows for both non-busy and busy potential responding SUs to be added to the location-based group.

After modifying (or eliminating) one or more rules in the initial set of location-based group formation rules to create a modified set of one or more location-based group formation rules that ignores the busy status of the potential responding SUs, the modified set of location-based group formation rules are re-applied to potential responding SUs in FIG. 3 meeting one of the plurality of required responder types, and a resultant re-formed group would include responding SU 112A (the required traffic control responder type), SU 114A (the required police car responder type), and SU 116A (the required fire engine responder type). While in this example the relaxing of the busy status rule resulted in a location-based group having exactly the minimum quantity of required responders for each responder type required for responding to the defined location, in other embodiments, similar preference rules as set forth above could be applied to reduce a quantity of potential responding SUs for any particular responder type due to the relaxing of the busy status rule and a re-formed group created with the preference rule applied.

### 2. EXAMPLE CONTROLLER FOR CREATING DYNAMIC LOCATION-BASED GROUPS FOR ENSURING MINIMUM REQUIRED RESPONDERS

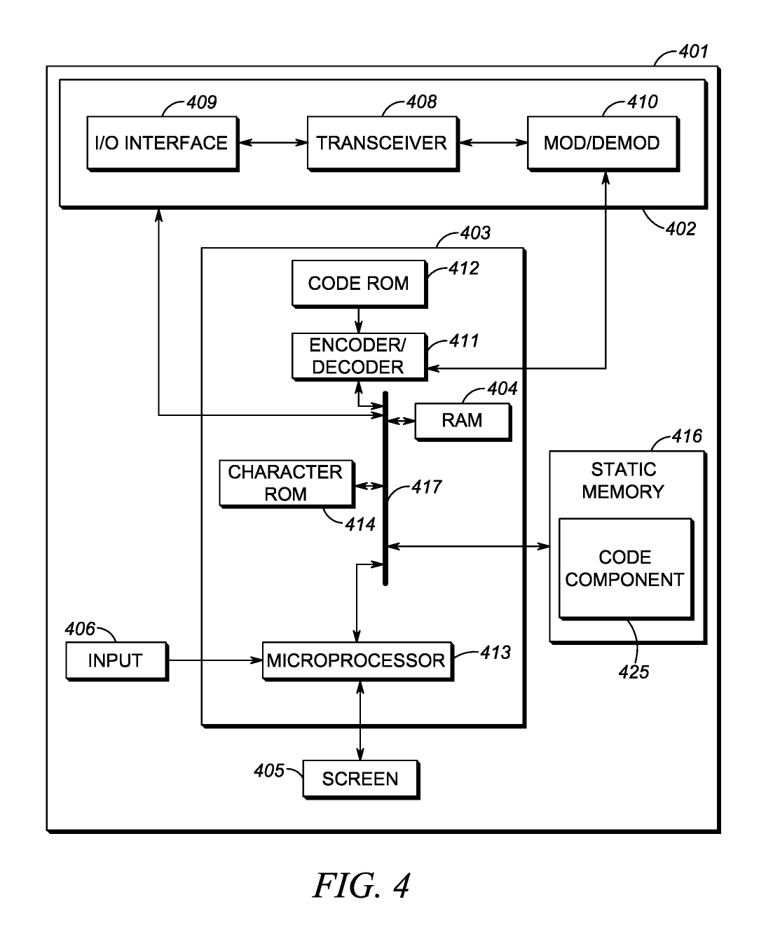

Referring to FIG. 4, a block diagram illustrates a controller 401, that may be the same or similar to controller 232 of FIGS. 2 and 3, that may be used in accordance with some embodiments for creating dynamic location-based groups for ensuring minimum required responders. The controller 401 includes a communications unit 402 coupled to a common data and address bus 417 of a processing unit 403. The controller 401 may also include an input unit (e.g., keypad, pointing device, etc.) 406 and a display screen 405, each coupled to be in communication with the processing unit 403.

The processing unit 403 may include an encoder/decoder 411 with an associated code ROM 412 for storing data for encoding and decoding voice, data, control, or other signals that may be transmitted or received by the controller 401. The processing unit 403 may further include a microprocessor 413 coupled, by the common data and address bus 417, to the encoder/decoder 411, a character ROM 414, a RAM 404, and a static memory 416. The processing unit 403 may also have access, via one or both of RAM 404 and static memory 416 or via I/O interface 409, to (i) a device ID to responder type mapping that maps each potential responding SU with a corresponding responder type, (ii) a requesting SU device type to required responder types mapping that indicates which required responder types should be included in any location-based group of responding SUs as a function of the responder type of the requesting SU device, and/or (iii) an incident type to required responder mapping that indicates what required responder types should be included in any group of responding SUs as a function of the type of incident being responded to. Other types of mappings and/or databases could be stored as well.

The communications unit 402 may include the I/O interface 409 configurable to communicate with network components (for example, fixed terminals, call controllers, databases, or dispatch consoles, among other possibilities), and other user equipment (for example, responding SUs) communicatively coupled to the controller 401 via wireless resources. The communications unit 402 may include one or more broadband and/or narrowband transceivers 408, such as a LTE transceiver, a 3G transceiver, an APCO P25 transceiver, a DMR transceiver, a TETRA transceiver, a WiMAX transceiver, and/or other similar type of wireless transceiver configurable to communicate via a wireless network for infrastructure communications. Additionally or alternatively, the communications unit 402 may include one or more local area network or personal area network transceivers 408 such as a Wi-Fi transceiver perhaps operating in accordance with an IEEE 802.11 standard (e.g., 802.11a, 802.11b, 802.11g), or a Bluetooth transceiver, for SD to SD communications. Additionally or alternatively, the communications unit 402 may include one or more wire-line transceivers 408, such as an Ethernet transceiver, a Universal Serial Bus (USB) transceiver, or similar transceiver configurable to communicate via a twisted pair wire, a coaxial cable, a fiber-optic link or a similar physical connection to a wire-lined network.

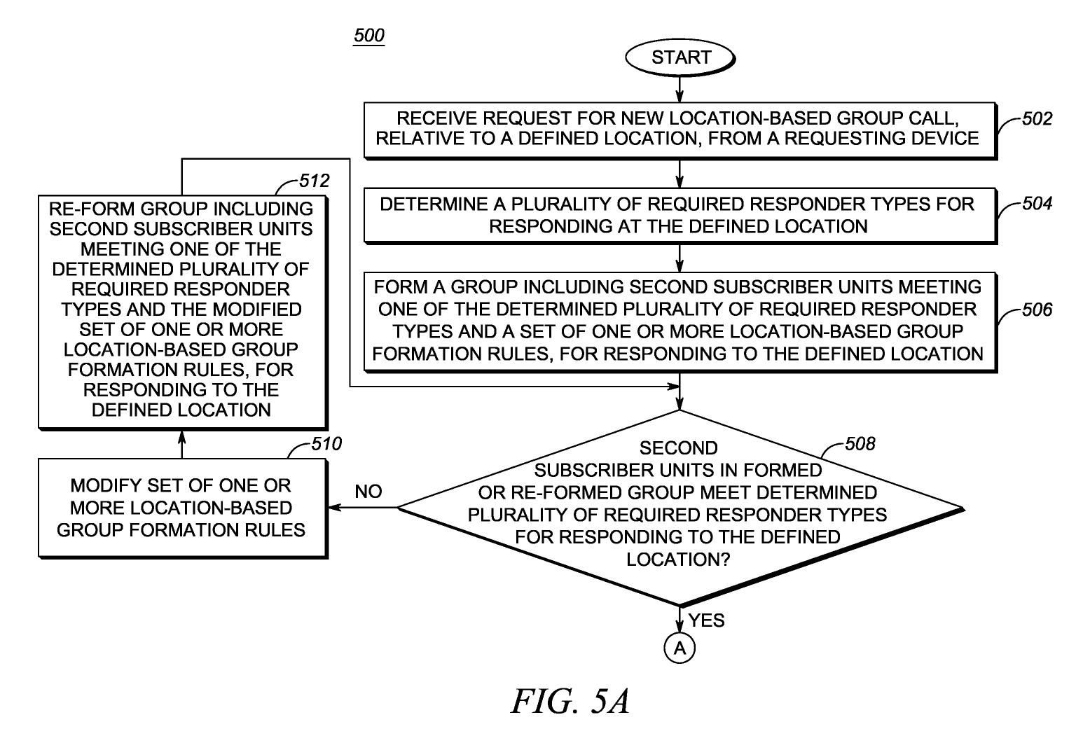

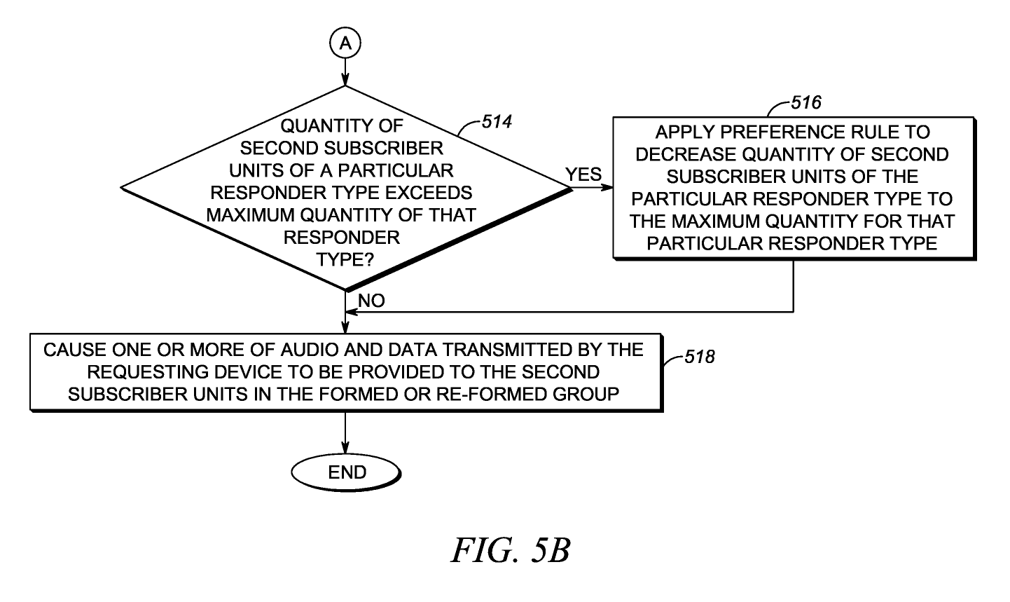

The transceivers may be coupled to a combined modulator/demodulator 410 that is coupled to the encoder/decoder 411. The character ROM 414 stores code for decoding or encoding data such as control, request, or instruction messages, audio and/or data that may be transmitted or received by the controller 401. Static memory 416 may store operating code that, when executed by microprocessor 413, causes the controller 401 to perform one or more of the processing steps and/or message transmissions and/or receptions set forth in FIGS. 5A and 5B, below.

### 3. PROCESS FOR CREATING DYNAMIC LOCATION-BASED GROUPS FOR ENSURING MINIMUM REQUIRED RESPONDERS

FIGS. 5A and 5B set forth a flow chart illustrating a process 500 including processing steps executable at the controller device 401 of FIG. 4 and/or controller device 232 of FIGS. 2 and 3 for creating location-based groups for ensuring required responders, in accordance with an embodiment. Of course, additional steps, receptions, and/or transmissions not disclosed herein could be additionally added before, after, or in-between steps, receptions, and/or transmissions disclosed in FIGS. 5A and 5B, and the presence of such additional steps, receptions, and/or transmissions would not negate the purpose and advantages of the examples set forth in detail throughout the remainder of this disclosure.

At step 502 in FIG. 5A, a controller in a RAN receives a request for a new location-based group call relative to a defined location from a requesting device (e.g., one of a first responding SU and a dispatch console). The defined location may be received in a same packet, instruction, header, or embedded control signal as the new group call request, or may be sent in a separate packet, instruction, header, or embedded control signal. The defined location may be a same location as the requesting device (e.g., first responding SU), may be a location manually entered by an operator of the requesting device (e.g., first responding SU or dispatch console), or may be some defined location automatically determined by the controller, perhaps with aid from other components within the RAN or outside of the RAN. The defined location may be comprised of, for example, GPS coordinates or other form of latitude and longitude coordinates. In other embodiments, Cartesian or polar coordinate systems could be used instead or in addition.

At step 504, the controller determines a plurality of required responder types for responding to the defined location. As set forth above, the plurality of types of required responders may determined as a function of one or more of (i) a responder type of the first, location-based group call requesting SU, (ii) a type of incident occurring to the defined location, and (iii) a content of the location-based group call request or some message transmitted by the requesting SU or dispatch console thereafter. In one embodiment, if the controller is unable to determine the required responder types on its own, it may transmit a request to the requesting SU or dispatch console requesting an indication of the plurality of required responder types, and once a response is received, may use the plurality of required responder types indicated in the response. In some embodiments, the controller may additionally or alternatively determine at step 504 a minimum and maximum quantity of required responders for each responder type required for responding to the defined location.

At step 506, the controller forms a location-based group (e.g., a talkgroup) including second SUs meeting one of the plurality of required responder types and an initial set of one or more location-based group formation rules, for responding to the defined location. The second SUs may be all potential responding second SUs active and/or known to the controller, a subset of all second subscriber units active and/or known to the controller (e.g., perhaps including those currently registered with one or more RANs providing wireless service to the defined location or in a threshold maximum region surrounding the defined location such as 1-5 miles), or a subset of all second SUs active and/or known to the controller that are particularly identified as available for participating in dynamically created location-based groups, among other possibilities. For example, with respect to FIG. 2, second SUs active and/or known to the controller 232 may include potential responding SUs 112A, 112B, 114A, 114B, 114C, 116A, 116B, 118A, and 118B.

The initial set of one or more location-based group formation rules may be a default set of rules governing location-based group formation that are stored and/or configured at the controller by a network or system administrator or installer. As set forth above, the default set of rules may include, for example, a default maximum distance from the defined location within which second SUs meeting the responder type requirement(s), among other rules in the set, will be added to the location-based group. For example, the default maximum distance may be in the range of 1-5 miles. The default set of rules may also contain a not-busy status requirement such that only second SUs meeting the responder type requirement(s) and the not-busy status requirement (among other rules in the set of rules) will be added to the location-based group.

Forming a location-based group may include, for example, assigning a unique talkgroup ID to the group of second SUs. The unique talkgroup ID may be stored at the controller, reported to a separate PTT server within or external to the same RAN as the controller, reported to the requesting device, and/or reported to the second SUs in the group. The unique talkgroup ID may be a reserved talkgroup ID that is reserved for dynamic location-based talkgroups, or may be a randomly generated talkgroup ID that is determined to not already be in use by other SUs in the RAN. In other embodiments, forming a group may include assigning a particular conventional or trunked traffic channel for the call, or direct mode channel or talk-around channel for the call, and informing the requesting device and/or second SUs in the group of the channel or channels assigned for the call. Other possibilities exist as well.

Once the location-based group is formed at step 506, at step 508, the controller determines whether second SUs in the formed group meet the determined plurality of required responder types, for responding to the defined location, set in step 504. If there is at least one missing required responder type in the formed group, the answer to step 508 is no and processing proceeds to step 510. In some embodiment, the controller may additionally or alternatively determine at step 508 whether second SUs in the formed group meet the minimum quantity of required responders for each responder type required for responding to the defined location, set in step 504. If there is at least one required responder type in the formed group having a quantity below the minimum quantity required responders, the answer to step 508 is no and processing similarly proceeds to step 510.

At step 510, one or more of the location-based group formation rules in the set of location-based group formation rules are modified (including, for example, being adjusted in value or being eliminated entirely from the rule set). As one example, and as set forth above, distance criterions may be expanded or busy status ignored or broadened at step 510. Processing then proceeds from step 510 to step 512, where the controller re-forms the location-based group including second SUs meeting one of the plurality of required responder types and the modified set of one or more location-based group formation rules, for responding to the defined location.

Processing then returns to step 508, from step 512, where the controller again determines if the second SUs in the re-formed group meet the determined plurality of required responder types (and/or the minimum required quantity of required responder types) for responding to the defined location. If the answer this time is yes, processing proceeds to step 514 in FIG. 5B. If the answer at step 508 is still no, processing returns to step 510 where an additional one or more location-based group formation rules are modified. Steps 508, 510, and 512 may be executed iteratively any number of times until either a re-formed group is created meeting the plurality of required responder types of step 504, or all rules in the set of one or more location-based group formation rules have been eliminated and a group still cannot be created that meets the plurality of required responder types of step 504 (in which case, processing would end and, in one embodiment, cause an error message to be sent to the requesting device informing the requesting device that a location-based group meeting the responder type requirements could not be created).

In some embodiments, processing would proceed directly from step 508 to step 518 of FIG. 5B. However, in other embodiments, the controller at step 514 of FIG. 5B may determine if a quantity of second SUs of a particular responder type (of those plurality of required responder types for responding to the defined location) exceed a maximum quantity of responders for that type. The maximum quantity of responders for any particular responder type may, in some embodiments, be equal to the minimum quantity of responders for that particular responder type (e.g., resulting in a group with an exact quantity of specified responders for that particular responder type), or in other embodiments, may be greater than the minimum number (e.g., allowing for a range in the quantity of responders for that particular responder type). For example, and as set forth above with respect to FIG. 2, a particular incident type may require only a single ambulance responder type, but an application of an initial or modified set of one or more location-based group formation rules may result in a group with two or more second SUs of an ambulance responder type. As set forth above, any mapping determining required responders may also set forth a maximum quantity of responders for each required responder type. In other embodiments, the maximum quantity of responders may be set manually by a requesting device or the dispatch console, among other possibilities.

At step 514, if the controller determines that a quantity of second SUs of a particular responder type exceeds the maximum quantity of responders for that responder type, processing proceeds to step 516, where a preference rule may be applied or added to the location-based group formation rules so as to reduce the quantity of responders for that particular responder type to the maximum quantity of responders for that particular responder type. As set forth above, a number of different types of preference rules could be applied to reduce the quantity of responders for a particular responder type, and they are not set forth again here. Once the preference rule is applied to reduce the quantity of responders for one or more particular responder types in the formed or re-formed group, processing proceeds to step 518.

At step 518, the controller causes one or more of audio and data transmitted by the requesting device to be provided to the identified second SUs in the formed (e.g., if steps 510, 512 were not executed) or re-formed (e.g., if steps 510, 512 were executed at least once) group.

In one example, the controller itself or a PTT server associated with the controller may receive audio and/or data from the requesting device destined for the second SUs in the formed or re-formed group, and may then forward, via one or more unicast, multicast, or broadcast transmissions, the received audio and/or data to the second SUs in the formed or re-formed group. In another example, the controller may assign a particular repeater (conventional or trunked) or pair of repeaters to a frequency (or pair of frequencies) assigned to the formed or re-formed group, such that the subsequent audio and/or data transmitted by the requesting device and received at the particular repeater (or one of the pair of particular repeaters) is subsequently repeated by the particular repeater (or other of the pair of particular repeaters) for receipt by the second SUs in the formed or re-formed group. In a still further example, the subsequent audio and/or data may be provided directly from the requesting device (e.g., first responding SU) to the second SUs in the formed or re-formed group via a direct mode transmission by the requesting device on an assigned direct mode or talk-around channel, perhaps using an assigned talkgroup identifier assigned by the controller. Finally, audio and/or data may be provided by the requesting device (e.g., the dispatch console) and routed, via the controller itself or via another device in the RAN under direction of the controller, to the second SUs in the formed or re-formed group via one or more repeaters assigned to the dispatch console-sourced call. Other possibilities exist as well.

### 4. CONCLUSION

In accordance with the foregoing, an improved method and apparatus for dynamically forming location-based group using variable distance parameters is disclosed, allowing incident and emergency response groups to be created more efficiently and more effectively when responding to an incident or emergency at a particular geographic location.

As a result, a more intuitive, useful, and efficient group communications system can be provided, improving communication capabilities of incidence response groups. Other advantages and benefits are possible as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of dynamic location-based group formation for ensuring required responders in a wireless radio communication system comprising a plurality of subscriber units, the method comprising:
receiving, by a controller from one of a first subscriber unit and a dispatch console, a request for a new location-based group call relative to a defined location;
determining a plurality of required responder types for responding to the defined location;
forming, by the controller, a group comprising second subscriber units out of the plurality of subscriber units meeting one of the plurality of required responder types and a set of one or more location-based group formation rules, for responding to the defined location; and
determining, by the controller, if second subscriber units in the formed group meet the determined plurality of required responder types for responding to the defined location;
if it is determined that second subscriber units in the formed group do not meet the determined plurality of required responder types for responding to the defined location:
modifying the set of one or more location-based group formation rules and re-forming, by the controller, the group comprising second subscriber units meeting one of the plurality of required responder types and the modified set of one or more location-based group formation rules, for responding to the defined location; and
causing, by the controller, one or more of audio and data transmitted by the one of the first subscriber unit and the dispatch console to be provided to the second subscriber units in the re-formed group; and
if it is determined that second subscriber units in the formed group do meet the determined plurality of required responder types for responding to the defined location:
causing, by the controller, one or more of audio and data transmitted by the one of the first subscriber unit and the dispatch console to be provided to the second subscriber units in the formed group.

2. The method of claim 1, further comprising determining a plurality of required responder types for responding to the defined location based on at least one of (i) a responder type of the first subscriber unit, (ii) a type of incident occurring at the defined location, and (iii) a content of the request.

3. The method of claim 2, wherein the determining the plurality of required responder types for responding to the defined location is based on the type of incident occurring at the defined location;
the method further comprising accessing, by the controller, an incident to responder type mapping that, for each of a plurality of incident types, indicates the plurality of required responder types for responding to the type of incident at the defined location.

4. The method of claim 2, wherein the determining the plurality of required responder types for responding to the defined location is based on a responder type of the first subscriber unit;
the method further comprising accessing, by the controller, an initiating device to responder type mapping that, for each of a plurality of initiating device responder types, indicates the plurality of required responder types for responding to the defined location.

5. The method of claim 1, wherein it is determined that second subscriber units in the formed group do not meet the determined plurality of required responder types for responding to the defined location:
the method further comprising determining a current location and a responder type of each of the plurality of subscriber units;
wherein the set of one or more location-based group formation rules includes a particular rule that each second subscriber unit must have a current location within a maximum distance from the defined location; and
wherein modifying the set of one or more location-based group formation rules comprises modifying the particular rule to increase the maximum distance from the defined location.

6. The method of claim 5, wherein the maximum distance varies based on the responder type of the second subscriber units.

7. The method of claim 1, wherein it is determined that second subscriber units in the formed group do not meet the determined plurality of required responder types for responding to the defined location;
wherein the set of one or more location-based group formation rules includes an availability rule that each second subscriber unit must not be identified as busy; and
wherein modifying the set of one or more location-based group formation rules comprises modifying the availability rule to allow second subscriber units that are identified as busy to be added to the re-formed group.

8. The method of claim 1, wherein it is determined that second subscriber units in the formed group do not meet the determined plurality of required responder types for responding to the defined location; and
wherein causing the one or more of audio and data transmitted by the first subscriber unit to be provided to the second subscriber units in the re-formed group comprises receiving the one or more of audio and data transmitted by the first subscriber unit at one of a push-to-talk (PTT) server and a repeater, and forwarding, via the one of the PTT server and the repeater, the one or more of audio and data transmitted by the first subscriber unit to the second subscriber units in the re-formed group.

9. The method of claim 1, wherein the request for the location-based group call is received from the dispatch console, and the defined location is determined based on a current location of the first subscriber unit.

10. The method of claim 1, wherein it is determined that second subscriber units in the formed group do not meet the determined plurality of required responder types for responding to the defined location;
the method further comprising assigning a group identifier to the re-formed group, and providing the group identifier to the one of the first subscriber unit and the dispatch console.

11. The method of claim 10, the method further comprising providing the group identifier to second subscriber units in the re-formed group.

12. The method of claim 11, wherein causing the one or more of audio and data transmitted by the first subscriber unit to be provided to the second subscriber units in the re-formed group comprises the first subscriber unit transmitting the one or more of audio and data with the group identifier, the second subscriber units in the re-formed group directly receiving the one or more of audio and data transmitted by the first subscriber unit, and the second subscriber units in the re-formed group playing back the received one or more of audio and data.

13. The method of claim 1, further comprising:
determining, based on the at least one of (i) the responder type of the first subscriber unit, (ii) the type of incident occurring at the defined location, (iii) an incident level metric associated with the incident occurring at the defined location, and (iv) the content of the request, a minimum required quantity of responders for each of the responder types for responding to the defined location;
determining that second subscriber units in the formed group do not meet the minimum required quantity of responders for each of the responder types for responding to the defined location, and responsively modifying the set of one or more location-based group formation rules and re-forming the group comprising second subscriber units meeting one of the plurality of required responder types and the modified set of one or more location-based group formation rules, for responding to the defined location.

14. The method of claim 13, wherein modifying the set of one or more location-based group formation rules comprises only modifying the location-based group formation rules with respect to the responder types that do not meet the minimum required quantity of responders.

15. The method of claim 1, further comprising:
determining, based on the at least one of (i) the responder type of the first subscriber unit, (ii) the type of incident occurring at the defined location, (iii) an incident level metric associated with the incident occurring at the defined location, and (iv) the content of the request, a maximum required quantity of responders for each of the responder types for responding to the defined location;
determining that second subscriber units in the formed group exceed the maximum required quantity of responders for at least one of the responder types for responding to the defined location, and responsively modifying the set of one or more location-based group formation rules to include a preference ranking rule and re-forming the group comprising second subscriber units meeting one of the plurality of required responder types and the modified set of one or more location-based group formation rules and according to the preference ranking rule such that less preferred second subscriber units are not added to the re-formed group if the less preferred second subscriber units would exceed the maximum required quantity of responders for a particular responder type.

16. The method of claim 1, wherein it is determined that second subscriber units in the formed group do not meet the determined plurality of required responder types for responding to the defined location; and
wherein the steps of (i) modifying the set of one or more location-based group formation rules and (ii) re-forming the group comprising second subscriber units meeting one of the plurality of required responder types and the modified set of one or more location-based group formation rules, are iteratively repeated a plurality of times until it is determined that second subscriber units in the re-formed group meet the determined plurality of required responder types for responding to the defined location.

17. A controller for dynamic location-based group formation ensuring required responders, the controller comprising:
a transceiver;
a data store; and
one or more processors configured to:
receive, via the transceiver, from one of a first subscriber unit and a dispatch console, a request for a new location-based group call relative to a defined location;
determine a plurality of required responder types for responding to the defined location;
form a group comprising second subscriber units out of the plurality of subscriber units meeting one of the plurality of required responder types and a set of one or more location-based group formation rules, for responding to the defined location;
determine if second subscriber units in the formed group meet the determined plurality of required responder types for responding to the defined location;
if it is determined that second subscriber units in the formed group do not meet the determined plurality of required responder types for responding to the defined location:
modify the set of one or more location-based group formation rules and re-forming the group comprising second subscriber units meeting one of the plurality of required responder types and the modified set of one or more location-based group formation rules, for responding to the defined location; and
cause, via the transceiver, one or more of audio and data transmitted by the one of the first subscriber unit and the dispatch console to be provided to the second subscriber units in the re-formed group; and
if it is determined that second subscriber units in the formed group do meet the determined plurality of required responder types for responding to the defined location:
cause, via the transceiver, one or more of audio and data transmitted by the one of the first subscriber unit and the dispatch console to be provided to the second subscriber units in the formed group.

18. The controller of claim 17, wherein the processor is further configured to determine a plurality of required responder types for responding to the defined location based on at least one of (i) a responder type of the first subscriber unit, (ii) a type of incident occurring at the defined location, and (iii) a content of the request.

19. The controller of claim 17, wherein the processor is further configured to:
determine a current location and a responder type of each of the plurality of subscriber units; and
responsive to determining that second subscriber units in the formed group do not meet the determined plurality of required responder types for responding to the defined location:
modify a particular rule in the set of one or more location-based group formation rules, indicating that each second subscriber unit must have a current location within a maximum distance from the defined location, to increase the maximum distance from the defined location.

20. The controller of claim 17, wherein the processor is further configured to, responsive to determining that second subscriber units in the formed group do not meet the determined plurality of required responder types for responding to the defined location:
modify an availability rule in the set of one or more location-based group formation rules, indicating that each second subscriber unit must not be identified as busy, to allow second subscriber units that are identified as busy to be added to the re-formed group.
